(19) United States
(12) Patent Application Publication
(10) Pub. No.: US 2004/0181801 A1
(43) Pub. Date: Sep. 16, 2004

(54) Interactive television for promoting goods and services

(76) Inventors: David Hagen, Southern Pines, NC (US); Thomas J. O'Hanlon, Whispering Pines, NC (US); Barrett Powell, Cary, NC (US)

Correspondence Address: SMITH MOORE LLP, P.O. BOX 21927, GREENSBORO, NC, 27420, US

(21) Appl. No.: 09/750,954

(22) Filed: Dec. 28, 2000

(51) Int. Cl. H04N 7/025; H04N 7/14; H04M 3/00; H04N 7/10; H04N 5/445; H04N 7/16; G06F 3/00; H04M 5/00; G06F 17/60

(52) U.S. Cl. 725/32; 348/14.11; 725/60; 725/42; 725/135; 705/27

(57) ABSTRACT

A set top box may in one embodiment enable customers to use their televisions to purchase through a live sales agent The set top box may have a high or low bandwidth bi-directional communication link that enables video conferencing through the television for the presentation of sales material to support the sales agent in his efforts to sell a product to the customer.

### RELATED APPLICATIONS

Copending U.S. patent application Ser. Nos. 09/614,399 and 09/680,796, filed 12 Jul. 2000 and 06 Oct. 2000 respectively are related to the present invention and are herein incorporated by reference in their entireties.

### BACKGROUND OF THE INVENTION

1. Field of the Invention

The present invention relates to a set top box for use with a television enabling interactive two-way live communication related to a sales opportunity.

2. Description of the Related Art

Internet commerce has exploded into the public awareness. The 1990s and first part of 2000 saw a flurry of activity in the industry as the “dot coms” advertised in such diverse locations as the Super Bowl, on the sides of buses, at trade shows, and the like. The initial burst of energy and investment focused on the Business to Consumer model. This fad passed when it rapidly became apparent that the potential purchasers did not complete some sixty to eighty percent of online transactions commenced.

This statistic remains prevalent even in the face of efforts to simplify the process, such as amazon.com's “one-click” technology, embodied in U.S. Pat. No. 5,960,411. This consumer reticence may be due in part to the complexity of the interfaces, the length of time required to complete the transaction, an aversion to sending financial data over the Internet, or some other factor as of yet unexplicated.

At the same time that online vending is undergoing an identity crisis in the face of unfulfilled customer orders, the traditional “brick-and-mortar” world is experiencing a marked dearth of qualified sales agents in the stores. Department stores are unable to compete with higher paying jobs and lose qualified technical sales agents to other more lucrative positions. The remaining sales force may not be knowledgeable about the products in the show room, and thus are unable to promote products effectively. This results in more lost sales opportunities.

Despite these concerns, the economic growth of the past decade has put more money in more people's pockets than seemingly at any other time in memory. Purchases will be made and the companies that figure out how to provide the desired interface for these customers will reap the benefits thereof.

At the same time that the Internet is exploding with new users and technology, other communication technology is also improving. Videophones, once thought to be science fiction, are now science fact. High speed, high bandwidth communication channels are now becoming commonplace in middle and upper income households. In this technology lies the key to solving the problems facing companies trying to sell to disgruntled and put out consumers.

### SUMMARY OF THE INVENTION

The present invention provides a videophone enabled set top box on a potential consumer's home television. The set top box is linked through high or low bandwidth communication connections to a remote call center staffed by trained sales agents. When the consumer sees an advertisement on the television for a product, the consumer may selectively activate the videophone and be connected to one of the sales agents at the call center. The sales agent will communicate with the consumer through the television, providing appropriate content in the form of web content, video clips, audio clips, or the like, to consummate a sale. Upon verification of the appropriate payment vehicle, the call center interfaces with the appropriate manufacturer and shipping company to deliver the just purchased good or service to the consumer.

In one low bandwidth embodiment, the visual representation of the sales agent is replaced with a “genie” or an animated head through which the sales agent may communicate. The sales agent speaks or types the message and the animated head appears to speak the message. This may be appropriate for corporate image reinforcement or for other reasons.

### BRIEF DESCRIPTION OF THE DRAWINGS

FIG. 1 illustrates a television with a set top box according to one embodiment of the present invention;

FIG. 2 illustrates a schematic diagram of one embodiment of the components of the set top box;

FIG. 3 illustrates a schematic diagram of one embodiment of a network via which the consumer may be connected to a remote sales agent;

FIG. 4 illustrates a first flow chart of a consumer purchasing a product through one embodiment of the present invention;

FIG. 5 illustrates a second flow chart of a consumer purchasing a product through a second embodiment of the present invention; and

FIG. 6 illustrates a third flow chart of a consumer purchasing a product through a third embodiment of the present invention.

### DETAILED DESCRIPTION OF THE INVENTION

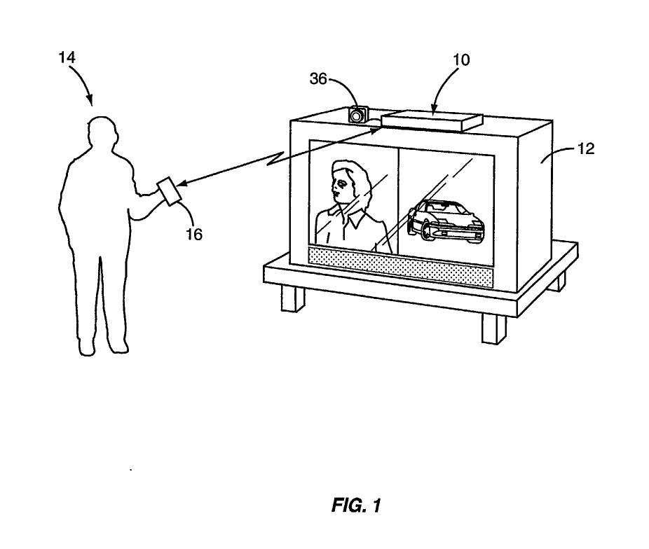

The present invention allows consumers to interact with qualified sales representatives from the comfort of their own home, in a simulated retail environment. The sales agent may provide additional content to the consumer via the television, or merely communicate over the videophone with the consumer. To help explain the sales methodology, an explanation of the hardware and software is in order. To that end, reference is made to FIG. 1, wherein a set top box 10 is illustrated positioned atop a television 12 for viewing by a consumer 14 in the comfort of their home. Note that a television is not strictly required, but any unit having a display such as a computer monitor, any Internet connected device with a display, IP address, web browser, and H 323 or similar interactively enabled device may also be appropriate. Thus, the term “remote unit” is herein defined to be a device with a screen capable of displaying video images.

Consumer 14 may be equipped with a remote control device 16 that wirelessly communicates with the set top box 10 and/or the television 12. Television 12 may be capable of operating with split screens 18 and have speakers 20. As an alternative to split screens 18, comparable technology such as picture-in-a-picture, overlay, or the like, may be substituted.

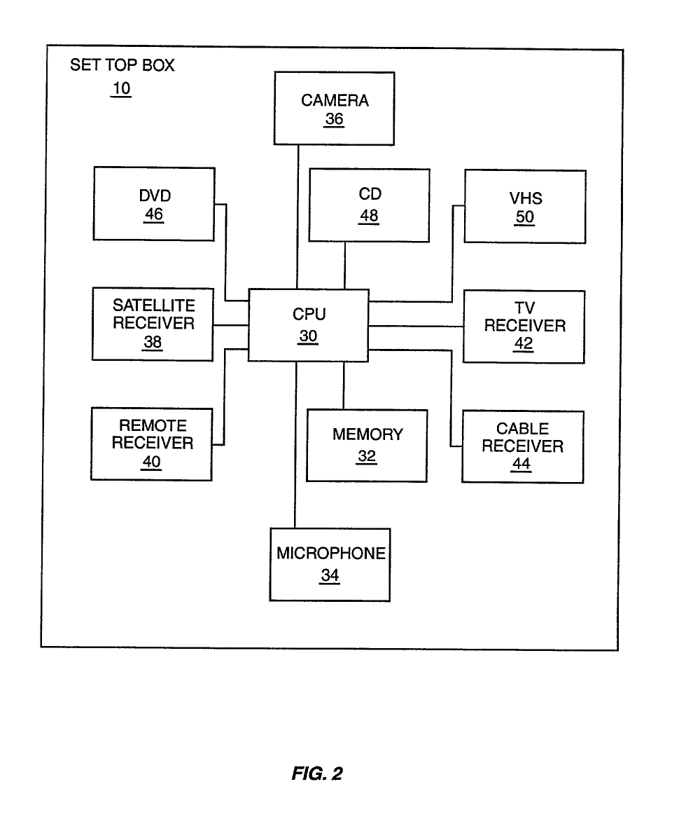

Set top box 10 is schematically illustrated in FIG. 2. In particular, set top box 10 comprises a central processing unit 30 such as an INTEL PENTIUM II, AMD K6, or the like microprocessor (or better) with associated motherboard. Potentially positioned on the same motherboard would be memory 32 that may be any appropriate memory such as RAM, ROM, or the like. Set top box 34 may further comprise a microphone 34, a camera 36, a satellite receiver 38, and a remote control unit receiver 40. Optionally, set top box may still further comprise a television receiver 42, a cable receiver 44, a DVD player 46, a CD player 48, and a VHS player 50. It should be appreciated that some of these units may be modularized and in separate boxes, but for the purposes of the present invention, such a modular set of stackable components also falls within the definition of set top box.

Further, software (not shown explicitly) may be stored in memory 32. The software may act to control the communication between the various components as well as run some of the functionality of the present invention. Alternatively, dedicated ASICs or other hardware may be created that are hardwired to perform the same functions. While not shown, it should be appreciated that the receivers mentioned above have the appropriate antennas.

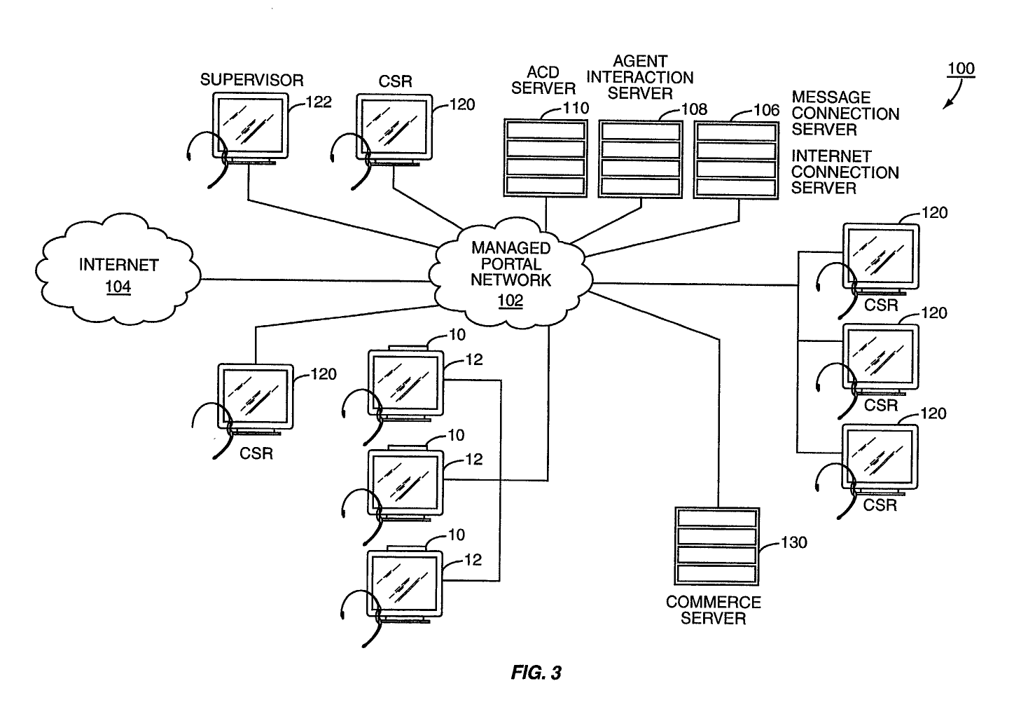

A plurality of set top boxes 10 operate within a communication system 100 as illustrated in FIG. 3. In particular, set top boxes 10 are part of a managed portal network 102 operated by a service provider operating according to the present invention. Managed portal network 102 interfaces with the Internet 104 and particularly with the World Wide Web (www). In managed portal network 102, each set top box 10 may be assigned an Internet Protocol (IP) address. To the extent that the managed portal network 102 is a private Wide Area Network (WAN), these IP addresses may be static and duplicative of other IP addresses used in the Internet 104 proper. To the rest of the Internet 104, the managed portal network 102 may appears as a single monolithic entity with a single IP address. A call center is also associated with the managed portal network 102. This call center may be comparable to that disclosed in the above identified related applications. Alternatively, the call center may be comparable to that disclosed in U.S. Pat. No. 6,046,762, the entire disclosure of which is hereby incorporated by reference. A brief overview of an appropriate system is herein provided to avoid the need to read those references. However, the interested reader is encouraged to read the references for a complete and full understanding of the call center. A message connection server 106, which may double as an Internet connection server, an agent interaction server 108, and an ACD server 110 may also form part of the managed portal network 102. Further, a plurality of customer service representative (CSR) stations 120 and supervisor stations 122 may be included within the managed portal network 102. Still further, a commerce server 130 may be part of the managed portal network 102. It should be appreciated that the communicative links between elements of the managed portal network 102 are high bandwidth, high speed connections such as T1 lines, E1 lines, broadband wireless links, two-way satellite communication, cable lines, fiber optic lines, or the like. However, data compression technology allows normal phone lines or twisted pair lines to be used if required.

Servers 106, 108, and 110 act to route messages from set top boxes 10 to CSR stations 120 and to the commerce server 130 as needed. CSR stations 120 comprise a camera (not shown explicitly), at least one monitor, a headset having a microphone and speaker capabilities, and other communicative capabilities. Each CSR station 120 is staffed by a trained sales agent having one or more specialty areas. As calls come in to the server 106, the server 106 routes the call to the appropriate CSR station 120. The accessed CSR station 120 may then begin bi-directional, interactive communication with the set top box 10 and the remote television 12. This interactive communication may take the form of a video phone call, content being pushed down the communicative link, or other form as needed or desired and as explained fully in the above incorporated copending applications.

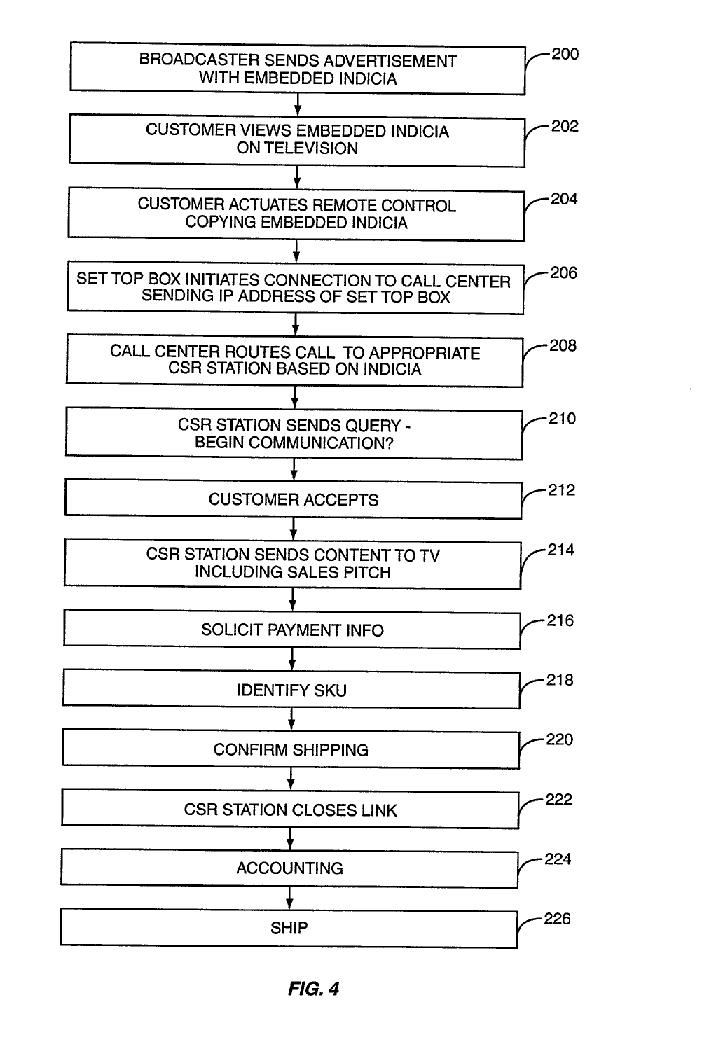

Variations on the methodology are presented in a clearer form below with reference to FIGS. 4-6. Initially, however, the service provider of the present invention approaches advertisers to use the service of the present invention. These advertisers will provide product catalogs for incorporation into the database of the call center. Sales agents are trained in the peculiarities of the products so that they are familiar with the products and can answer customer questions in relation thereto. The product catalogs are imported into the commerce engine server 130 and organized in a coherent fashion.

The service provider also creates a database of the advertisements and the times at which they will be broadcast. The creation of this database may be done by interfacing with the broadcast stations. The interface may result in the broadcasters providing a guide as to the times and channels on which the advertisements will run or the like. This database will be helpful as described below.

FIG. 4 illustrates a first embodiment of the methodology of the present invention. After having made the appropriate arrangements with the advertisers and the broadcasters, the broadcaster sends an advertisement with embedded indicia to the television 12 or other remote unit (block 200). The broadcaster may use a conventional wireless broadcast, a cable broadcast, a satellite broadcast or the like as needed or desired. The advertisement is most likely going to be a typical commercial, such as a thirty second spot during a sit com or the like. The embedded indicia may be an alphanumeric sequence or the like. Further, the embedded indicia may be selectively displayable on the display of the television 12, much like a closed caption service. Alternatively, the embedded indicia may be a ghost image in a corner of the screen, much like a company logo is frequently ghosted into corners of the screen (e.g., the CBS eye). Still other techniques of displaying the embedded indicia are also possible.

The customer 14 watching the television 12 views the embedded indicia on the television 12 (block 202). Having an interest in the item advertised, the customer 14 actuates the remote control device 16, copying the embedded indicia (block 204). For example, if the embedded indicia were #2334, the customer 14 would punch that sequence of keys on the remote control device 16. As noted above, the remote control device 16 communicates with the set top box 10. Set top box 10 communicates with the call center, and specifically the message connection server 106 through the managed portal network 102 (block 206). This communication includes the IP address of the set top box 10. The call center, and specifically the message connection server 106 routes the call to the appropriate CSR station 120 based on the indicia (block 208). For example, if the advertisement was a FORD EXPLORER commercial, the code tells the message connection server 106 that the customer 14 is interested in a FORD EXPLORER, and the call is routed to a CSR station 120 having a sales agent knowledgeable about FORD EXPLORERs.

Because the remote control device 16 may have been actuated in error, the CSR station 120 sends a query to the customer 14 asking if they would like to begin the communication (block 210). Note that the CSR station 120 has the IP address of the set top box 10 that placed the call, so this return call is easily enabled. Customer 14 then accepts the incoming call from the CSR station 120 (block 212). If the customer has a memory device attached to the television 12, it may be possible for the customer to pause the present programming that they are watching so as to conclude the transaction without missing any of the show that they were watching. Such memory devices are commercially available under the brand name TIVO.

The sales agent at the CSR station 120 now effectively takes over the television 12 of the customer 14. A videophone communication link is established. An image of the sales agent appears on the television 12 (FIG. 1), while the customer 14 is filmed by the camera 36 and this image is transmitted to the sales agent at the CSR 120. The sales agent may split the screen of the television 12 and display multimedia content to the customer 14 to illustrate the sales pitch (block 214). Preplanned multimedia messages may be displayed, web pages may be accessed, or other content may be sent to the customer to help the sales agent provide the sales pitch. This may be done by treating the television 12 as a remote desktop or other comparable techniques. One such technique comprises the T120 collaboration standards or the like. If all goes well for the sales agent, the customer 14 consents to the sale and the sales agent may solicit payment information from the customer 14 (block 216). Further, the sales agent may identify with particularity the product the customer is purchasing by the SKU number (block 218). The sales agent may interact with the commerce engine 130 during the sales pitch entering the customer 14's information as solicited. The commerce engine 130 may likewise interact with an external courier's web site such as FEDERAL EXPRESS or UPS to acquire a shipping number and confirm a shipping date (block 220).

After completion of the sales interaction, the CSR station 120 closes the link to the set top box 10 (block 222). Any necessary accounting is done (block 224). This may include securing authorization from a credit card company, accounting within the service provider for the transaction, commissions provided to the sales agent, and the like. The product is then shipped to the customer 14 (block 226). As another optional payment vehicle, the call center may be equipped to handle electronic “wallet” transactions. These electronic wallet features offer a secure and direct method of payment with an Internet enabled financial settlement partner such as Bank of America or other major financial institutions.

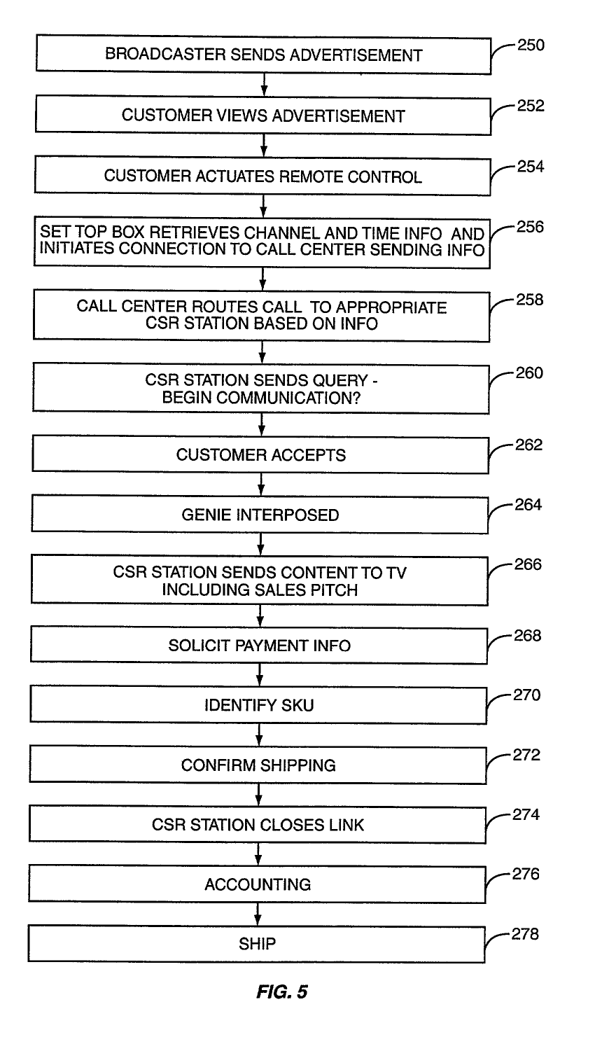

In an alternate embodiment, illustrated in FIG. 5, the same initial process of coordinating the advertising and the broadcasting occurs and the broadcaster sends the advertisement (block 250). Again, this advertisement may be a commercial. The customer 14 views the advertisement (block 252) and actuates the remote control device 16 (block 254). This time, the set top box retrieves information about the channel the customer 14 is watching and a time stamp. For example, the set top box 10 retrieves channel 6 at 4:12 PM. The set top box initiates a call to the call center and specifically the message connection server 106, sending the retrieved information along with the IP address of the set top box beginning the inquiry (block 256).

The call center, and particularly the message connection server 106 routes the call to the appropriate CSR station based on the information provided (block 258). This is accomplished by referencing a look up table or comparable database to ascertain that the channel viewed at that particular time contained an advertisement for a particular product. The call is then routed to a sales agent trained to sell that product. For example, at 4:12 PM on channel 6, an EDDIE BAUER commercial was airing, so the call is connected to an EDDIE BAUER trained sales agent at a CSR station 120.

The CSR station 120 sends an inquiry as to whether the customer 14 wishes to begin communication (block 260). The customer 14 may then accept the incoming call from the CSR station 120 (block 262). In one embodiment, the customer 14 does not see the sales agent himself, but rather a “genie” such as those programmed by LIPSinc of Research Triangle Park, N.C. and documented at www.lipsinc.com may be interposed (block 264). These genies may be animated heads that speak for the sales agent. The genie may be made to speak by typing in the text that is to be spoken, through voice recognition software or the like as needed or desired. The genie may be used to reinforce a trademark or present a particular corporate image. For example, DISNEY may wish to have MICKEY MOUSE be their spokesperson for all these transactions. A sales agent qualified to know the full line of products sold in DISNEY STORES may still interface with the customer 14, but through the MICKEY MOUSE genie.

CSR station 120 sends content to television 12 by way of the set top box 10 including the sales pitch (block 266). As previously described, the sales pitch may involve a multimedia presentation by which the sales agent (with or without the genie) sells the product or service to the customer 14. The screen of the television 12 may be split so that multiple information streams may be presented concurrently or in different formats as needed or desired.

The remaining steps are very similar to that already described. The sales agent solicits payment information (block 268); the SKU is identified (block 270); and the shipping is confirmed (block 272) with the courier. After completion of the transaction the CSR station 120 closes the link (block 274); any accounting is performed (block 276); and the product or service is shipped to the customer 14 (block 278).

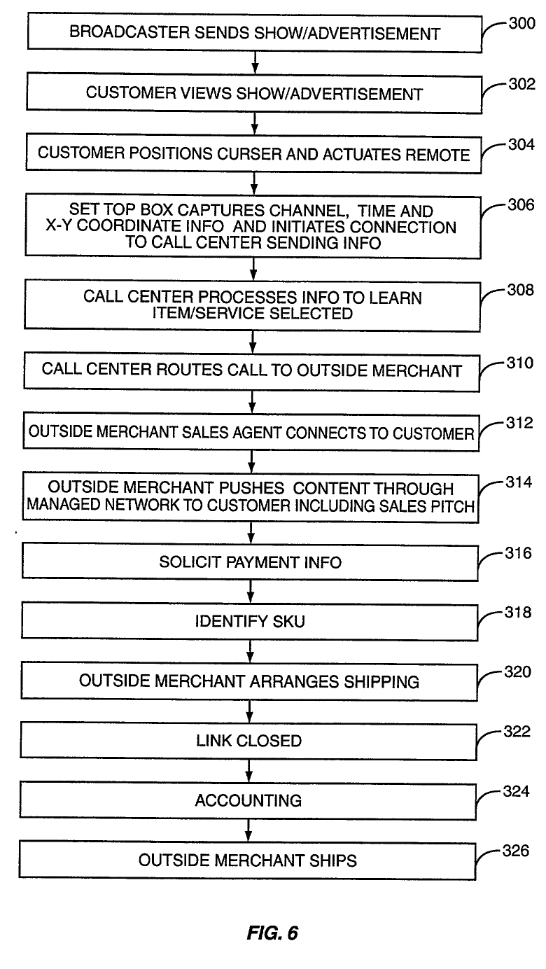

A third embodiment of the present invention is illustrated in FIG. 6. This embodiment is more sophisticated still. After the initial coordination between the advertisers and the broadcasters, the broadcaster airs the advertisement (block 300). The customer 14 views the advertisement (block 302). In this embodiment, the customer 14 positions a curser or pointer over an item displayed in the advertisement and actuates the remote control device 16 (block 304). Set top box 10 captures the channel, time stamp and x-y coordinate of the curser/pointer on the screen of the television. The capturing of the x-y coordinate may be done with many conventional display/mouse drivers such as are commonly used in the computer industry. Alternatively, the pointer may be an IR signal that is detected on the television screen and translated into an x-y coordinate. Having acquired the desired information, the set top box 10 initiates a connection to the call center, and specifically to the message connection server 106 and sends the captured information thereto (block 306).

The call center process the captured information, perhaps using a look up table or other database to determine what product was being aired at that particular x-y coordinate, on that channel, at that time (block 308). Of course, threshold values may be used so that misaimed selections may still be assumed to be close enough to a valid target. The call center in one embodiment may not route the call to a sales agent within the managed portal network 102, but rather routes the call to a sales agent associated with a merchant outside the managed portal network 102 (block 310). The outside merchant then connects to the customer 14 (block 312) through the managed portal network 102. In particular, the outside merchant through an audiovisual connection comparable to that described above pushes content to the customer 14 (block 314). The difference here is rather than run the entire transaction and the sales activity, the service provider derives revenue by the pass through function. While perhaps not as valuable as controlling the whole sale, it may make more strategic sense to pass a customer 14 through the managed portal network 102 to an outside merchant who already has a viable sales force and call center.

Again the final steps are fairly comparable to the closing steps described above except that the outside merchant solicits payment information (block 316); identifies the SKU (block 318); and arranges shipping (block 320). The link is then closed (block 322); any accounting is performed (block 324) and the outside merchant ships the product (block 326).

Note that while the processes described above are contemplated as being initiated during commercials, it is possible that the customer 14 may actuate the remote during normal shows. This is alluded to in block 300 of FIG. 6. For example, shows could have embedded indicia linked to clothing actors are wearing, products they are consuming or the like. Again these codes could be selectively viewable, and upon viewing the customer 14 could enter the appropriate code. Likewise, for the second embodiment, the customer could see a show and just actuate the remote control device 16 to connect the customer 14 to the call center. The call center may screen the customer 14, perhaps through a person, through menu selection, or through voice recognition software as to what on the screen caused the customer 14 to actuate the remote control device 16. The call could then be routed appropriately. For example, on a particular show on channel 8 at 3:07 PM, the customer 14 views an actor driving a FORD EXPLORER, drinking a COKE, and wearing AMERICAN EAGLE clothes. The customer 14 actuates the remote control device 16. The call center is contacted and asks if the customer 14 wishes to be connected to a sales agent. The customer 14 replies affirmatively. The call center then performs its look up and determines the three products displayed at that time on that channel. The call center then asks the customer in which of the three products the customer is interested. The call is routed appropriately depending on the reply of the customer 14. This inquiry stage is eliminated in the curser model because the call center would know exactly what the customer 14 had clicked on and be able to route the call directly based on the original actuation. Thus, for the purposes of the present invention, the term “advertisement” includes shows which would not normally be considered an advertisement under the normal understanding of that term. This is not a contrary understanding of the term, because many companies pay for product placement advertising in shows as it presently stands.

Note further that while the processes of FIGS. 4-6 are described as linear processes, because humans are involved, many of the steps may be rearranged to suit the needs of the parties involved. The present flow charts are meant to be illustrative and not limiting. Further, many of the features of the three flow charts may be mixed and matched. The genie of the second embodiment may be used with either the first or third embodiments. The outsourcing of the sales agent to outside merchants may likewise be done with either the first or second embodiments. Other variables may be changed as needed or desired to achieve the claimed functionality.

As an exemplary setup, the satellite receiver 38 may comprise a conventional RCA receiver with an RCA satellite dish acting as the antenna. As is conventional a coaxial cable or other suitable communicative connector may connect these two devices. The RCA receiver may be connected to an AGP ATI 128 RAGE PRO TV tuner's TV In port by a coaxial cable and thence through an AGP ATI 128 RAGE PRO chipset to the television 10 by an S-video cable. In this example, suitable software would comprise the DIRECTV Embedded Receiver Control Application, an operating system such as WINDOWS 98SE, the ATI TV Tuner, the ATI RAGE PRO 128 driver, and DIRECTX 7.0a. Remote control device 16 may comprise a wireless remote keyboard/pointer such as Model #IR9703-RC. Remote control receiver 40 may be a complementary wireless receiver Model #IR9703-RC.

Set top box 10 may further interface in this embodiment through the appropriate PS/2 connections with a keyboard and/or mouse if desired. Controller 30 may be an Intel BX PIII 700 MHz motherboard running WINDOWS 98SE. Stored in memory is a JAVA application that receives the request from the remote control receiver 40. It sends a request to the satellite receiver 38 and its software. In the event that the satellite receiver 38 is contained in a separate unit, the request may be through a cable. That request is asking for the channel and programming information presently being displayed on the television 12. Upon return of the information, the controller 30 launches a web browser such as INTERNET EXPLORER™ or NETSCAPE NAVIGATOR™. The web browser launches an HTTP request to the remote call center with the channel information and address information. Based on the channel and programming information, the call center, and particularly the message connection server 106 routes the incoming call to the appropriate CSR station 120. In a land based embodiment, this HTTP request goes out from the set top box 10 through a PCI port adapted to use a COMPAQ FAST ETHERNET ADAPTER, over an ALCATEL 1000 DSL MODEM to the managed portal network 102 and specifically to message connection server 106. Once the potential customer 14 is connected, a bi-directional videophone call is established through the television 12 and the camera 36. A conventional H 323 video conferencing protocol may be used to enable this feature. Then, as previously described in the incorporated applications, the sales agent may push multi-media content through the communication link to the television 12 to consummate the sale. It should be appreciated that the particular hardware components listed here do allow the device to function as desired, but the present invention is not limited to such as setup. Rather other components may be substituted as needed or desired to achieve a smoother picture, a more detailed resolution, or the like if needed or desired.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A method of promoting commerce, comprising:
displaying an advertisement for a product on a remote unit;
accepting input through a device associated with said remote unit, said input from a potential consumer related to said advertisement;
connecting said potential consumer to a sales agent through said remote unit for an interactive sales pitch.

2. The method of claim 1 wherein displaying an advertisement for a product on a remote unit comprises displaying on advertisement on a television.

3. The method of claim 1 further comprising selectively displaying indicia associated with said advertisement concurrently with said advertisement.

4. The method of claim 3 wherein accepting input through a device associated with said remote comprises said potential customer entering the indicia a remote control device.

5. The method of claim 1 wherein displaying an advertisement for a product on a remote unit comprises displaying a television program on the remote unit.

6. The method of claim 1 wherein displaying an advertisement for a product on a remote unit comprises displaying a commercial on the remote unit.

7. The method of claim 1 further comprising determining the position of a customer positioned pointer to determine a product in which said customer is interested.

8. The method of claim 1 further comprising viewing by said sales agent a video feed from said customer.

9. The method of claim 1 wherein connecting said potential consumer to a sales agent through said remote unit for an interactive sales pitch comprises said sales agent pushing multimedia content down a high bandwidth connection to said customer for viewing on said remote unit.

10. The method of claim 9 wherein pushing multimedia content down a high bandwidth connection to said customer comprises using a satellite connection to push content to said customer.

11. The method of claim 9 wherein pushing multimedia content down a high bandwidth connection to said customer comprises using a wire based connection to push content to said customer.

12. A communication apparatus comprising:
a remote control device;
a set top box capable of wireless communication with said remote control device;
a remote unit communicatively connected to said set top box; and
a controller positioned within said set top box and adapted to control said display and receive input from said remote control device, said controller adapted to receive information relating to data presented on the display from the remote control device and establish a communication link to a remote location where a sales agent is located, said controller adapted to relinquish control of said display to said sales agent for interactive communication between the sales agent and a potential consumer associated with the remote control device.

13. The system of claim 12 wherein said remote unit is a television.

14. The system of claim 12 wherein said communication link is adapted to be created over a satellite system.

15. The system of claim 12 wherein said communication link is adapted to be created over a cable network.

16. The system of claim 12 wherein said set top box further comprises a DVD player.

17. The system of claim 12 wherein said set top box further comprises a CD player.

18. The system of claim 12 wherein said set top box further comprises a VHS player.

19. An interactive sales process comprising:
displaying an advertisement on a remote unit;
inducing a customer to actuate a remote control device to connect the remote unit to a remotely positioned sales agent through the remote unit;
establishing a two way audiovisual communication link between the sales agent and the customer; and
presenting content originating with the sales agent on the remote unit for viewing by the customer to promote a sale.

20. The method of claim 19 wherein presenting content originating with the sales agent comprises presenting a video image of the sales agent on the remote unit.

21. The method of claim 19 wherein presenting content originating with the sales agent comprises presenting an audio signal from the sales agent and a genie video representation of the sales agent.

22. The method of claim 19 further comprising allowing the sales agent to direct web pages to the customer for viewing on the remote unit.

23. The method of claim 19 further comprising soliciting payment information from the customer.

24. The method of claim 23 further comprising generating shipping information for the customer after soliciting payment information.

25. A method for enabling sales, comprising:
providing a plurality of trained sales agents;
accepting an incoming call with information about an advertisement a potential customer was watching;
directing said incoming call to one of said plurality of trained sales agents based on said information;
directing a multimedia, interactive, videophone communication from said one of said plurality of trained sales agents to said customer including content select from the group consisting of: web pages, prefilmed video clips, statistical data, still images, and a genie; and
soliciting payment information from the customer to consummate the sale.

26. The method of claim 25 wherein directing said incoming call to one of said plurality of trained sales agents comprises directing said incoming call to a sales agent within a managed portal network.

27. The method of claim 25 wherein directing said incoming call to one of said plurality of trained sales agents comprises directing said incoming call to a sales agent outside a managed portal network.

28. The method of claim 25 wherein soliciting payment information from the customer to consummate the sale comprises soliciting a credit card number from the customer.

29. The method of claim 25 further comprising arranging for shipping the good sold to the customer.

30. The method of claim 29 further comprising providing the customer with some information relating to the shipping.

31. The method of claim 25 wherein accepting an incoming call with information about an advertisement a potential customer was watching comprises accepting an incoming call with indicia related to embedded indicia in the advertisement.

32. The method of claim 25 wherein accepting an incoming call with information about an advertisement a potential customer was watching comprises accepting an incoming call with channel and timestamp information.

33. The method of claim 25 wherein accepting an incoming call with information about an advertisement a potential customer was watching comprises accepting an incoming call with channel, timestamp, and x-y coordinate information, said x-y coordinate relating to a location selected on the remote unit by the customer.

34. The method of claim 25 wherein accepting an incoming call with information about an advertisement a potential customer was watching comprises accepting an incoming call over a wirebased network.
